(19) United States
(12) Patent Application Publication
(10) Pub. No.: US 2010/0216091 A1
(43) Pub. Date: Aug. 26, 2010

(54) CAST MOUNTING FOR ARTICULATOR

(76) Inventor: Enzo Gambacorta, Harrison, NY (US)

Correspondence Address: ITALIA IP, 3500 WEST OLIVE AVE., SUITE 300, BURBANK, CA, 91505, US

(21) Appl. No.: 12/393,653

(22) Filed: Feb. 26, 2009

(51) Int. Cl. A61C 11/00

(52) U.S. Cl. 433/60

(57) ABSTRACT

A mechanical interfitting connector for repeatably connecting dental models of teeth to articulators without damaging the former. The connector may comprise a socket mountable to a model and a male member mountable to the articulator, wherein the male member enters and engages the socket. The socket may be adhered to the model or alternatively partially embedded therein. A screw may be passed through the socket and male member so as to leave a small marking on the dental model, thereby indexing the socket and model for subsequent mountings, and also to prevent disengagement of the male member from the socket. A supplementary plate may be provided to secure anchoring of the male member to the socket, and to shield plaster which has not fully hardened against damage during hardening.

### REFERENCE TO RELATED APPLICATION

This application is related to my prior U.S. Pat. No. 7,303,393, issued Dec. 4, 2007.

### FIELD OF THE INVENTION

The present invention relates to dental articulators, and more particularly to an arrangement for connecting dental casts to dental articulators, for example of the type shown in my prior patent.

### BACKGROUND OF THE INVENTION

It is often necessary for dentists in evaluating teeth of patients to prepare models of upper and lower teeth of a patient. These models frequently must be mounted on an articulator, which is a support device that holds the models and enables the models to be pivoted in a motion which essentially reproduces the action of opening and closing the jaws. This is done to observe appropriate dimensions and configuration of the models so as to assure that the teeth will meet in natural fashion when closing the jaw. The meeting of upper and lower teeth is called bite registration in the dental field.

Articulators traditionally provided for observing bite registration have suffered from the deficiency that mounting of each model, that is, a model of the upper teeth and a second model of the lower teeth, results in breakage of the plaster base to which the realistic models are mounted for connection to the articulator. While bite registration may be successfully observed in some cases, there are nonetheless many situations in which it is desirable to subsequently remount and recheck the models for bite registration.

### SUMMARY OF THE INVENTION

The present invention provides a way for dental practitioners to install on, remove from, and reinstall on articulators dental models of the mouth as many times as desired, with no significant damage being done to the models. Usually, the models are mounted to articulators using a freshly prepared plaster base.

U.S. Pat. No. 7,303,393, of common inventorship with the present application, shows a dental articulator to which dental cast models of the teeth and partial jaws of a patient may be fixed to evaluate bite registration for example. The issued patent addresses the problem of repeated assembly of upper and lower jaw casts within an articulator. The present invention provides an additional method of connecting a cast to an articulator.

Whereas the approach of my priorly issued patent relies upon magnetic attraction, the approach in the present invention relies upon mechanical interfit. To this end, the invention may provide mating male and female members which slidingly interfit. One of the male and female members is fixed to a plaster cast of the model of the patient's physiology, and the other member is fixed to the articulator.

According to one aspect of the invention, the female member or socket may be fixed to the plaster in any suitable way. For example, the socket may be adhered by a suitable glue. In another example, the socket may be partially embedded within the plaster prior to the plaster being cured.

It is an object of the invention to enable dental models of upper and lower teeth to be mounted on an articulator in a way that avoids damage to the models such that the models may be subsequently mounted on the articulator for additional observations.

Another object of the invention is to provide apparatus and method for repeatably mounting a plaster base model to an articulator using a mechanical interfit approach.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a side view of models of upper and lower teeth mounted to an articulator according to at least one aspect of the invention.

FIG. 2 is an exploded view of novel connection apparatus used to mount the models to the articulator of FIG. 1, according to at least one aspect of the invention, and shown at enlarged scale.

FIG. 3 is a cross sectional detail view of elements seen at the upper right of FIG. 1.

FIG. 4 is a perspective view of an alternative mounting of a model for connection to an articulator.

FIG. 5 is a side view of FIG. 4, shown partially in cross section.

FIG. 6 is a perspective view of an alternative form of an element seen at the center of FIG. 2.

### DETAILED DESCRIPTION

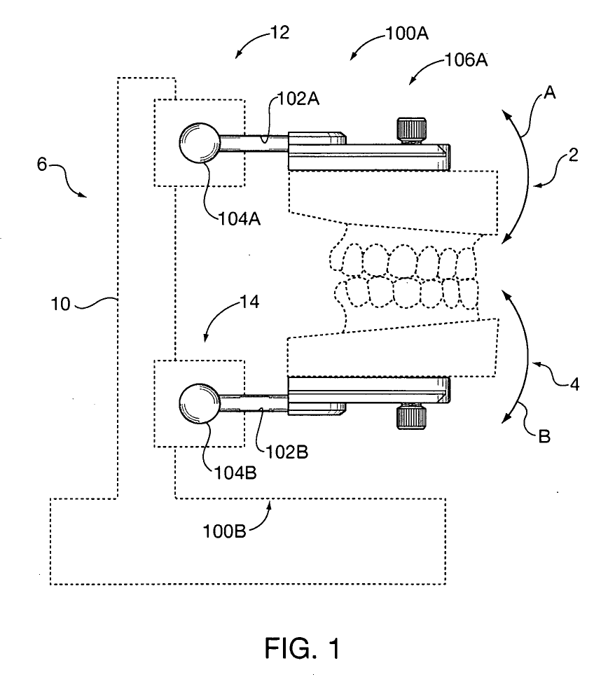

FIG. 1 of the drawings shows a mounting arrangement for use in mounting dental models 2, 4 of respective upper and lower teeth to a dental articulator 6 for example, for the purpose of checking bite registration. The novel mounting arrangement enables a dental practitioner to remount the dental models 2, 4 in the same spatial orientation as the previous mounting, should a subsequent exercise in checking bite registration be necessary. The novel arrangement further enables this to be accomplished without destructive disassembly of the dental models 2, 4 after the first mounting and checking.

The dental articulator 6 may be any known dental articulator including for example the articulator shown in my issued U.S. Pat. No. 7,303,393. Therefore, the dental articulator 6 is shown only in abbreviated form, and will be understood to incorporate all of the functions and adjustments which would be found in a fully functional articulator. Nonetheless, to review some of the functions and structural features of articulators generally, the articulator 6 may comprise a base 8 for holding the articulator 6 erect on a horizontal surface such as a work bench (not shown), a vertical column 10, a first clamp 12, and a second clamp 14. The purpose of the clamps 12 and 14 is to grasp that structure which is connected to and supports the dental models 2, 4, while allowing the dental models 2, 4 to be moved through motions simulating bite registration.

The mounting arrangement may further comprise a first holder 100A for supporting the dental model 2 and a second holder 100B for supporting the dental model 4 in a way enabling the dental models 2, 4 to be moved as described above. This motion may be arcuate, and is indicated in FIG. 1 by the arrows A and B. The holder 100A may be regarded as comprising the clamp 12 and a connector 106A for detachable connection to the dental model 2. The connector 106 may comprise an arm 102A and a ball 104A which is movably held within the clamp 12.

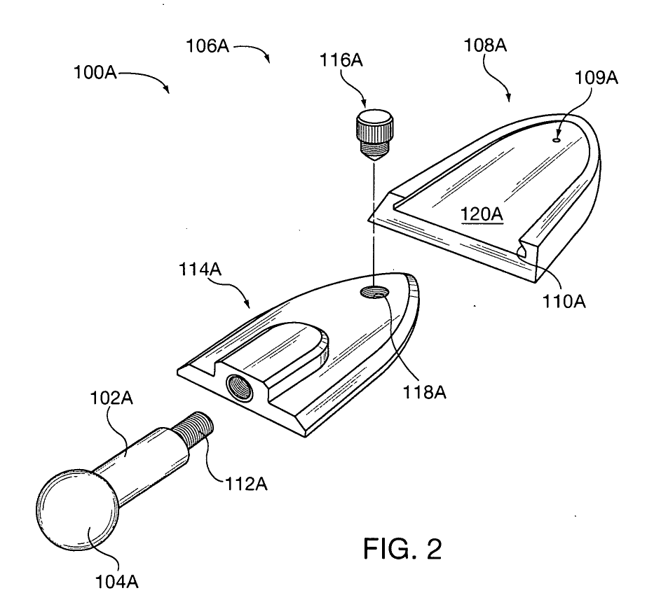

Also referring to FIG. 2, the first connector 106A may further comprise a socket 108A further comprising a receptacle 110A, which socket 108A may be mounted to the dental model 2. The connector 106A may further comprise a support finger 112A which is dimensioned and configured to be received within the receptacle 110A of the socket 108A in close cooperation therewith.

The first connector 106A may comprise an enlarged head 114A which is dimensioned and configured to be received within the receptacle 110A of the socket 108A in close cooperation therewith, and which is coupled to the support finger 112A. The enlarged head 114A may serve the functions of providing a larger, more easily maneuvered element when assembling the dental model 2 to the articulator 6, and may more securely engage the socket 108A than would be the case if the socket 108A were configured to receive the small, cylindrical support finger 112A directly. The support finger 112A may be inserted into an opening 116A formed in the enlarged head 114A and suitably retained therein, for example using adhesive, friction, or in any other way. Alternatively, the enlarged head 114A may be formed integrally with the arm 102A or with the support finger 112A.

The enlarged head 114A may be configured as a spade, so called due to visual similarity with typical configuration of spade shovels. The receptacle 110A of the socket 108A would in such cases obviously be configured to take on a corresponding configuration in order to receive the enlarged head 114A in close cooperation.

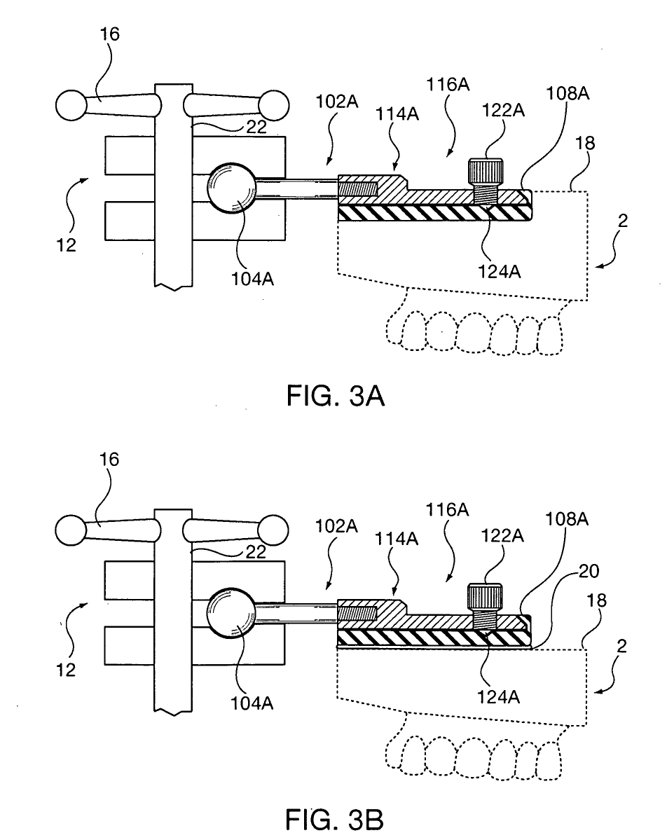

Another function of the enlarged head 114A is to accommodate an indexing screw 116A. The indexing screw 116A may be dimensioned and configured to thread into a threaded hole 118A which is oriented to pass through the enlarged head 114A and intersect the dental model 2, and when the socket 108 is fitted to the enlarged head 114A, penetrate through the floor 120A of the socket 108A into the dental model 2 (best seen in FIG. 3). Whereas the enlarged head 114 may be fabricated from metal for example, the socket 108A may be fabricated from an inexpensive material such as plastic. Such construction both enables the indexing screw 116 to penetrate the floor 120A of the socket 108A, and also renders the socket 108A to be regarded as being an inexpensive and disposable member.

The indexing screw 116A, which may be grasped and tightened by a knurled head 122A, may have a pointed end 124A which pierces the constituent plaster of the dental model 2 and leaves a discernible hole (not shown) therein. This mark will serve to index the connector 106A to the dental model 2, or alternatively stated, to enable a dental practitioner to realign the socket 108A accurately to the same position in subsequent assembling operations on the dental model 2 that was used in the first assembly of the dental model 2 to the articulator 6.

FIG. 3 also shows a tightening handle 16 which may be used to adjust pressure of the clamp 12 which acts on the ball 104A. The tightening handle 16 may be part of a screw (not shown) employed to draw the elements of the clamp 12 together, thereby squeezing the ball 104A therein. Further details on such a construction may be obtained from U.S. Pat. No. 7,303,393. Appropriate pressure will retain the ball 104A but will allow the ball 104A to accommodate the arcuate motion represented as arrow A in FIG. 1. The ball 104A, the clamp 12, and the cooperation therebetween will be understood to provide a hinge arrangement enabling the dental model 2 of the upper teeth to be moved relative to the other dental model 4 so as to simulate bite registration. This may of course require similar or corresponding mobile mounting of the dental model 4, such as mirror image mounting as depicted n FIG. 1. It should be stressed at this point that the novel mounting arrangement may include a second set of mounting components for mounting the dental model 4 to the articulator 6, which mounting components include identical or corresponding structure and function as those described above, with the exception that the mounting of the dental model 4 may be in mirror image relation to that of the dental model 2.

To this end, the dental model 4 may be provided with an arm 102B and associated ball 104B which are generally identical counterparts of the arm 102A and ball 104B, and which are used with the clamp 14. Because of this potential similarity between the mounting of the dental models 2 and 4, specific description of the corresponding components of the dental model 4 need not be set forth in detail. It should be understood however that different mounting arrangements for the two dental models 2 and 4 may be provided if desired. It is only necessary that the resultant mounting enable for example simulation and checking of bite registration. Therefore, it is possible to mount one of the dental models 2 and 4 in stationary fashion to the articulator 6 if desired, and to provide mobility in only the other of the dental models 2 and 4.

Referring specifically to FIG. 3, the socket 108A may have surface which engages the upper surface 18 of the dental model 2. The socket 108A may be adhered to this upper surface using a suitable adhesive such as methyl methacrylate.

Alternatively, and referring momentarily to FIG. 6, a socket 208A which in other ways may be the structural and functional equivalent of the socket 108A, may have a surface which is adapted to embeddingly engage uncured plaster. For example, the socket 208A may have denticles 209A which may penetrate uncured plaster of a dental model such as the model 2, and may be permanently retained therein by embedment.

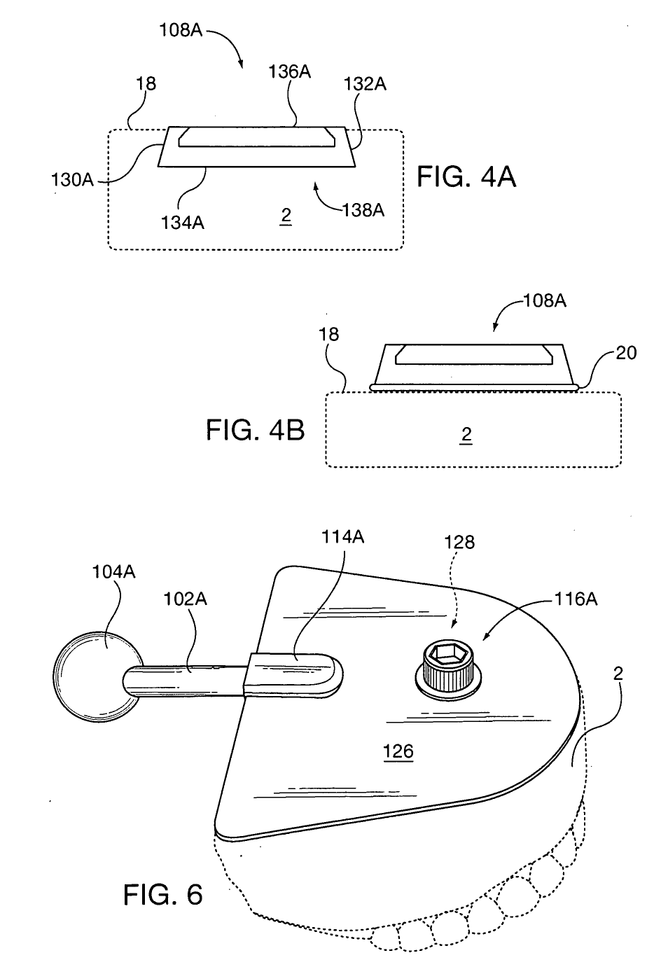

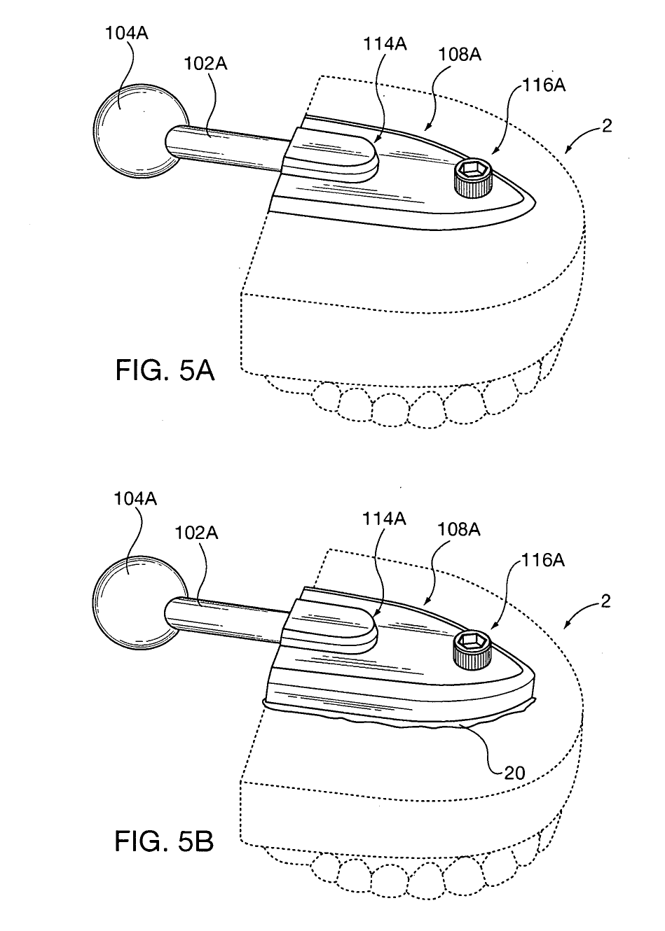

FIGS. 4 and 5 show a mounting arrangement which is generally similar to that of FIG. 1. However, in the mounting shown in FIG. 4, the connector such as a connector corresponding to the connector 106A may comprise a supplemental plate 126 which is dimensioned and configured to cover at least most of the surface of the dental model 2. The supplemental plate 126 may be connected to the enlarged head 114A by the same indexing screw 116A described prior, and hence to the arm 102A of an associated connector such as the connector 106A. The supplemental plate 126 may be installed over the enlarged head 114A. Of course, a hole 128 may be formed in the supplemental plate 126 to accommodate passage of the indexing screw 116A. The supplemental plate 126 may more stably engage the dental model 2, and if used when the constituent plaster of the dental model 2 is not cured, may be used to cure to the dental model 2. This may protect the upper surface 18 (see FIG. 3) of the dental model 2 during final curing of the plaster.

The invention may also be regarded as a method of mounting dental models of upper and lower teeth of a patient, such as the dental models 2 and 4, on a dental articulator such as the dental articulator 6 in a manner enabling ready disassembly and subsequent reassembly. This method may comprise the steps of mounting a connector such as the connector 106A which is formed in at least two interfitting parts such as the enlarged head 114A and the socket 108A to at least one of the dental models 2 or 4, and to a dental articulator such as the dental articulator 6; and mounting the remaining dental model 4 or 2 to the articulator.

An important feature of the invention is that the term “interfitting”, as employed herein, connotes friction fit, interference fit, or other mutual engagement of a mechanical nature between the separable components. In the example of FIG. 1, the enlarged head 114A may frictionally engage the socket 108A, instead of or in addition to the interference provided by the indexing screw 116A. The mechanical engagement is different from magnetic engagement, as seen in my prior U.S. Pat. No. 7,303,393. While the mechanical interfit of the present invention opposes spontaneous disengagement, it can be overcome by manual pressure or manual manipulation without damaging the models 2 and 4, and is therefore not only interfitting in nature, but must be regarded as repeatably removably mating in nature.

The method may comprise the further step of installing an indexing device such as the indexing screw 116A to one of the models of the upper and lower teeth, such as the dental models 2 and 4, such that the positional orientation of the model to which the indexing device is installed may be reproduced in subsequent installations of the model to its associated connector, such as the connector 106A, which connects the model to the articulator.

The method may comprise a still further step of installing an indexing device such as the indexing screw 116A to the other one of the models of the upper and lower teeth such that the positional orientation of the other model may also be reproduced in subsequent installations to its associated connector.

It should be stressed that while the above description refers to attachment of the female part of the mechanically interfitting connection elements to the dental model, such as the socket 108A to the dental model 2, it would be possible to reverse the locations of the male and female elements of the connector 106A to similar effect.

It would also be possible to use an entirely different mounting approach to mounting the remaining dental model to the articulator. For example, a detachable, non-destructive mechanically interfitting connector according to the present invention, such as the connector 106A, may be used to mount either dental model, such as either of the dental models 2 or 4, to the articulator, while a different mounting arrangement may be used for the other dental model 4 or 2. The different mounting arrangement may take a magnetic approach, as seen in my issued U.S. Pat. No. 7,303,393, or may be a conventional destructive type permanent mounting, or may be still another type of mounting.

It should also be stressed that the novel mounting arrangement of the present invention may be applied to either the model of the upper teeth, such as the model 2, or to the model of the lower teeth, such as the model 4, or to both models.

It would further be possible to retain to a dental model, such as the model 2, a member of the connection which has been described as disposable, such as the socket 108A, if desired. It would further be possible to form such members as non-disposable.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A mounting arrangement for use in mounting dental models of upper and lower teeth to a dental articulator, comprising:
a dental articulator comprising a first holder for supporting a dental model of the upper teeth, a second holder for supporting a dental model of the lower teeth, and a hinge arrangement enabling dental models of the upper teeth and the lower teeth to be moved relative to one another so as to simulate bite registration, wherein the first holder further comprises
a first clamp fixed to the articulator, and
a first connector for movably connecting the dental model of the upper teeth to the first clamp, the first connector further comprising
a socket comprising a receptacle, which is selectively mountable to one of the first holder of the dental articulator and the dental model of the upper teeth, and
a support finger which is dimensioned and configured to be received by mechanical interfit within the receptacle of the socket in close cooperation therewith, and which is engageable with the other of the first holder of the dental articulator and the dental model of the upper teeth.

2. The mounting arrangement of claim 1, wherein the socket of the first connector comprises a disposable member.

3. The mounting arrangement of claim 1, wherein the socket of the first connector comprises a structure adapted to embeddingly engage uncured plaster.

4. The mounting arrangement of claim 1, wherein the first connector comprises an enlarged head which is dimensioned and configured to be received within the receptacle of the socket in close cooperation therewith, and which is coupled to the support finger.

5. The mounting arrangement of claim 4, wherein the enlarged head of the first connector is configured as a spade.

6. The mounting arrangement of claim 1, wherein the first connector has a threaded hole oriented to intersect the dental model of the upper teeth, and wherein the mounting arrangement further comprises a screw which is dimensioned and configured to thread to the threaded hole and to pierce the dental model of the upper teeth sufficiently so as to index the first connector to the dental model of the upper teeth, thereby enabling accurate subsequent reassembly of the first connector to the dental model of the upper teeth.

7. The mounting arrangement of claim 1, wherein the first connector comprises a supplemental plate which is dimensioned and configured to cover at least most of the surface of the dental model which is connected to the first connector, whereby an exposed surface of uncured plaster of the dental model of the upper teeth is covered and protected during final curing.

8. The mounting arrangement of claim 1, wherein the second holder further comprises:
a second clamp fixed to the articulator, and
a second connector for movably connecting the dental model of the upper teeth to the second clamp, the second connector further comprising
a socket comprising a receptacle, which is selectively mountable to one of the second holder of the dental articulator and the dental model of the lower teeth, and
a support finger which is dimensioned and configured to be received by mechanical interfit within the receptacle of the socket in close cooperation therewith, and which is engageable with the other of the second holder of the dental articulator and the dental model of the lower teeth.

9. The mounting arrangement of claim 8, wherein the socket of the second connector comprises a disposable member.

10. The mounting arrangement of claim 8, wherein the socket of the second connector comprises a structure adapted to embeddingly engage uncured plaster.

11. The mounting arrangement of claim 8, wherein the second connector comprises an enlarged head which is dimensioned and configured to be received within the receptacle of the socket of the second connector in close cooperation therewith, and which is coupled to the support finger.

12. The mounting arrangement of claim 11, wherein the enlarged head of the second connector is configured as a spade.

13. The mounting arrangement of claim 8, wherein the second connector has a threaded hole oriented to intersect the dental model of the lower teeth, and wherein the mounting arrangement further comprises a screw which is dimensioned and configured to thread to the threaded hole and to pierce the dental model of the lower teeth sufficiently so as to index the second connector to the dental model of the lower teeth, thereby enabling accurate subsequent reassembly of the second connector to the dental model of the lower teeth.

14. The mounting arrangement of claim 8, wherein the second connector comprises a supplemental plate which is fixed to the second connector and is dimensioned and configured to cover at least most of the surface of the dental model which is connected to the second connector, whereby an exposed surface of uncured plaster of the dental model of the lower teeth is covered and protected during final curing.

15. A method of mounting dental models of upper and lower teeth of a patient on a dental articulator in a manner enabling ready disassembly and subsequent reassembly, comprising the steps of:
mounting a connector which is formed in at least two mechanically interfitting parts to at least one of the dental models and to the dental articulator; and
mounting the remaining dental model to the articulator in a manner which will not damage the dental model during disassembly of the dental model from the dental articulator.

16. The method of claim 15, comprising the further step of installing an indexing device to one of the models of the upper and lower teeth such that the positional orientation of the model to which the indexing device is installed may be reproduced in subsequent installations of the model to its associated connector which connects the model to the articulator.

17. The method of claim 15, comprising the further step of installing an indexing device to the other one of the models of the upper and lower teeth such that the positional orientation of the model to which the indexing device is installed may be reproduced in subsequent installations of the other model to its associated connector which connects the other model to the articulator.
